(19) United States
(12) Patent Application Publication
(10) Pub. No.: US 2013/0259137 A1
(43) Pub. Date: Oct. 3, 2013

(54) System and Method for Multi-Core Hardware Video Encoding And Decoding

(71) Applicant: Aki Kuusela, Oulu (FI)

(72) Inventor: Aki Kuusela, Oulu (FI)

(73) Assignee: GOOGLE INC., Mountain View, CA (US)

(21) Appl. No.: 13/460,024

(22) Filed: Apr. 30, 2012

Related U.S. Application Data
(60) Provisional application No. 61/618,189, filed on Mar. 30, 2012.

(51) Int. Cl. H04N 7/26

(52) U.S. Cl. 375/240.24; 375/240.01; 375/E07.026

(57) ABSTRACT

Methods and systems for performing a coding operation on video data using a computing device having plurality of cores are disclosed. In one aspect the method includes loading at least a first portion of the video data from a primary memory into an associated memory of a first core of a plurality of cores, performing a coding operation, by the first core, on the first portion of the video data, directly loading at least part of a first reference portion from the first core into the associated memory of a second core of the plurality of cores, loading at least a second portion of the video data from the primary memory into the associated memory of the second core of the plurality of cores, and performing the coding operation, by the second core, on the second portion of the video data using the first reference portion as a reference.

### CROSS-REFERENCE TO RELATED APPLICATIONS

This application claims priority to U.S. Provisional Patent Application No. 61/618,189, filed Mar. 30, 2012, which is hereby incorporated by reference in its entirety.

### BACKGROUND

A video encoder can get a new video frame along with reference video frame(s) as inputs, and output a compressed video bitstream. A video decoder can get a compressed video bitstream as input, and output uncompressed (or decoded) video frames. When decoding inter-frames, previous (reference) frames are used for decoding.

Video resolution and frame rate requirements are getting higher and higher. Beyond 1080p, there can be challenges to provide the required data throughput using fixed-function hardware accelerators whose performance is limited by the maximum clock frequency at which the logic circuits can run.

### SUMMARY

Disclosed herein are embodiments of systems, methods, and apparatuses for multi-core hardware video encoding and decoding.

One aspect of the disclosed embodiments is a method for performing a coding operation on video data using a computing device that includes primary memory, a plurality of cores each having an associated memory, and a bus coupling the primary memory to one or more of the plurality of cores. The method includes storing the video data in the primary memory, loading, via the bus, at least a first portion of the video data from the primary memory into the associated memory of a first core of the plurality of cores, performing a coding operation, by the first core, on the first portion of the video data, loading at least part of a first reference portion from the first core into the associated memory of a second core of the plurality of cores, wherein the first reference portion is loaded directly without being stored in the primary memory, loading, via the bus, at least a second portion of the video data from the primary memory into the associated memory of the second core of the plurality of cores, and performing the coding operation, by the second core, on the second portion of the video data using the first reference portion as a reference.

Another aspect of the disclosed embodiments is a computing device. The computing device includes a plurality of cores, each core of the plurality of cores having an associated memory, a primary memory coupled to the associated memory of two or more of the plurality of cores by respective input lines of an internal bus, wherein the first core of the plurality of cores is configured to perform a video data coding operation on a first portion of video data loaded into its associated memory from the primary memory that includes generating a first reference portion, and wherein the second core of the plurality of cores is configured to perform a video data coding operation on a second portion of video data loaded into its associated memory from the primary memory using the first reference portion that is loaded into the associated memory of the second core directly from the associated memory of the first core.

These and other embodiments will be described in additional detail hereafter.

### BRIEF DESCRIPTION OF THE DRAWINGS

The description herein makes reference to the accompanying drawings wherein like reference numerals refer to like parts throughout the several views, and wherein:

FIG. 1 depicts schematically a hardware implementation of a video decoder;

FIG. 2A depicts a timing diagram for a traditional single core video processor;

FIG. 2B depicts a timing diagram for a staged three-core video processor;

FIG. 3 illustrates a synchronization technique in accordance with an implementation of this disclosure;

FIG. 4 depicts a multi-core computing device in accordance with an implementation of this disclosure;

FIG. 5 depicts a multi-core computing device in accordance with another implementation of this disclosure;

FIG. 6 depicts a process in accordance with an implementation of this disclosure;

FIG. 7 depicts a process in accordance with the implementation of FIG. 6; and

FIG. 8 depicts a schematic of a multi-core computing device in accordance with an implementation of this disclosure.

### DETAILED DESCRIPTION

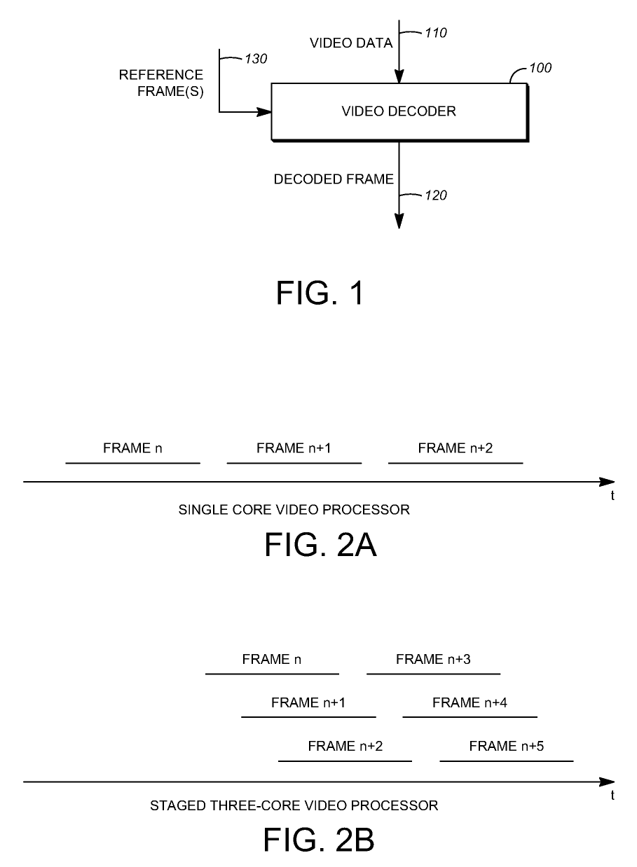

FIG. 1 depicts schematically a hardware implementation of a video decoder. Video decoder 100 can get video data 110 as its input (e.g., a video bitstream), and can output decoded frames (e.g., decoded frame 120). When decoding inter-frames, reference frame(s) 130 can be used for decoding. Analogously, a hardware implementation of a video encoder can get new image and reference video data as inputs, and can output compressed video data.

A multi-core computing device in accordance with an implementation of this disclosure has two or more processors (called cores) placed within the same integrated circuit. Each of the cores can perform a coding operation (e.g., encoding, decoding, or transcoding) on some portion of input video data.

A multi-core computing device can perform coding operations for a variety of video compression standards. By way of example, these standards can include, but are not limited to, Motion JPEG 2000, H.264/MPEG4-AVC, DV, and VP8.

In an implementation of a multi-core solution, several copies of a hardware accelerator module (e.g., cores) can be placed on the same application specific integrated circuit (ASIC), and the modules can be used to process different portions of a video bitstream (e.g., frames or macroblocks of video data) at the same time. In implementations where the bus and memory architecture is not a performance limiting factor, the multi-core solution can effectively multiply data throughput.

FIG. 2A depicts a timing diagram for a traditional single core video processor. A traditional single core video processor processes video frames sequentially. For example, FIG. 2A shows frames n, n+1, and n+2 processed in a sequential fashion (e.g., a frame (such as frame n+1) is processed after a last frame (such as frame n) has been processed).

FIG. 2B depicts a timing diagram for a staged three-core video processor. In the implementation shown in FIG. 2B, frames n through n+5 are processed in a concurrent, but staged fashion. Frames n and n+3 are processed by a first core, frames n+1 and n+4 are processed by a second core, and frames n+2 and n+5 are processed by a third core. Frames n, n+1, and n+2 can be processed concurrently, with the processing of each frame being started at a staged time. In this example, the processing of frame n is started first, the processing of frame n+1 is started after a portion of the processing of frame n is completed, and the processing of frame n+2 is started after a portion of the processing of frame n+1 is completed.

Encoding and/or decoding of video data can involve accessing previously processed reference data (e.g., for motion search in an encoder and motion compensation in a decoder). In a multi-core solution, processing by the different cores can be staged and synchronized so that the cores can access the previously processed reference data while different frames are processed concurrently (e.g., delaying the processing of a later frame until the reference data from a previous frame is available).

In one implementation of a multi-core computing device performing video encoding operations, synchronization among the individual cores can be solved as follows when the requirement for the available reference frame area is directly dependent on the motion search area size. As an example, assume that the encoder's motion search area is +/−32 pixels around a current macroblock (MB). In such an example, each encoder instance can be started when the instance handling the previous frame is at least 32 pixel rows (two MB rows) ahead.

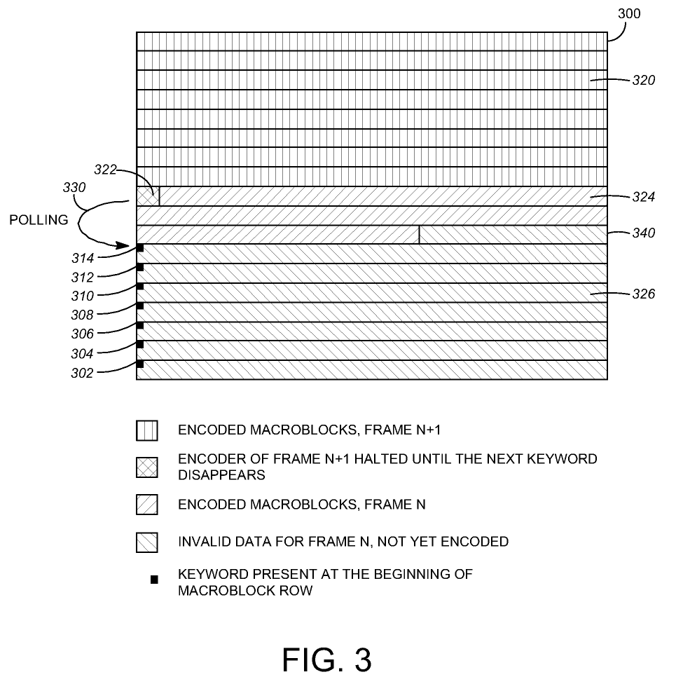

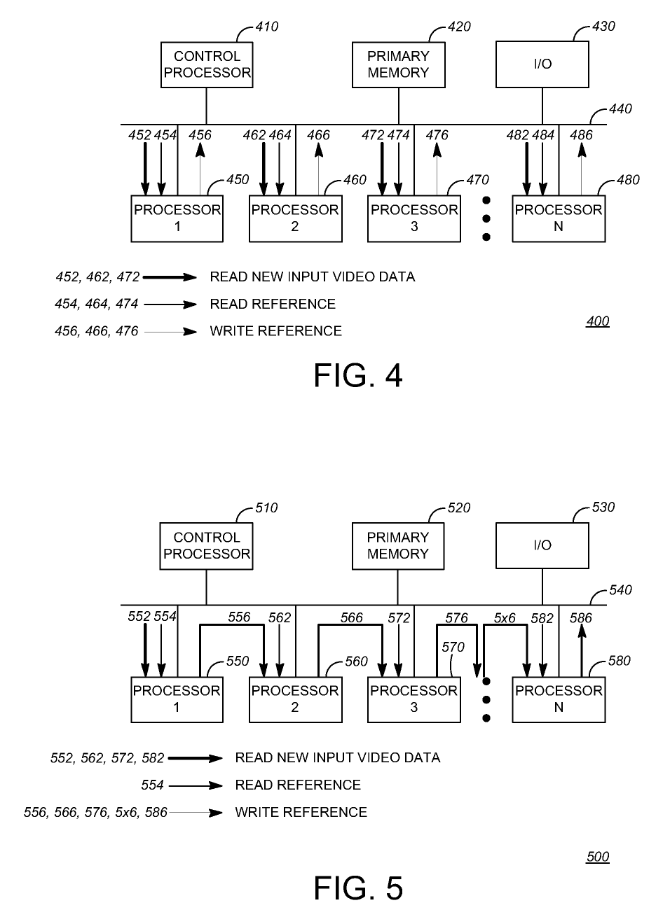

In one aspect of this disclosure, synchronization can be handled by checking the status of a previous encoder's progress (e.g., at the beginning of each MB row). An implementation of this aspect is explained in further detail with reference to FIG. 3. In another aspect of this disclosure, the reference data generated by a first encoder is fed directly to the next encoder, and the synchronization is handled by managing the flow of data. An implementation of this aspect is explained in further detail with reference to FIGS. 4 and 5.

FIG. 3 illustrates a synchronization technique in accordance with an implementation of this disclosure. In FIG. 3, the synchronization technique uses a reference frame buffer for MB row synchronization.

In an implementation consistent with FIG. 3, before starting to encode a new frame in hardware, control software can write a keyword (e.g., 0x007FAB10), such as keywords 302-314, to an address (e.g., a first address) of each macroblock row (e.g., row 300) in the reference frame memory 340. For example, if operating at 1080p resolution, there can be 1088/16=68 macroblock rows and associated write operations per frame.

In an implementation, an encoder can encode a current frame (e.g., frame N+1) using a reference frame (e.g., frame N). The current frame can be encoded at the same time as the reference frame is being encoded (e.g., the current frame can be encoded using one core and the reference frame can be encoded using another core).

For example, as shown, some blocks of the current frame have been encoded, including block 320. A current block 322 is a next block to be encoded from the current frame. Also shown are some blocks of the reference frame that have been encoded, such as block 324 and some blocks of the reference frame that have not been encoded, such as block 326.

The blocks from the reference frame and the current frame are shown concurrently for reference only. In practice, the blocks from the reference frame and the current frame can be represented and stored separately in memory, such as a primary memory and/or a memory associated with a core.

To maintain synchronization (e.g., to ensure that reference data needed to encode the current frame is available), an encoder can read the keyword memory location at the beginning of each MB row within a motion estimation search area of a current block that is being encoded from the current frame and a MB row immediately below the motion estimation search area of the current block.

The motion estimation search area can extend, for example, two blocks above and below the current block. If the encoder does find the keyword in any of the locations described above, then the encoder can determine that the lowest MB row in the reference frame belonging to the motion search area has not been processed. If the keyword exists, then the encoder may enter a polling mode 330 where it can wait for the keyword to change from the keyword value.

Synchronization for a decoder can be done in an analogous fashion, for example, by using a keyword check during motion compensation. In an implementation, a decoder keyword check may be done before a motion vector is used for decoding. As described with respect to the encoder, a keyword value can be written to each macroblock row in one or more reference frame buffers. During decoding, for example, a determination can be made as to whether a motion vector references a reference block in a macroblock row that has not been previously used for decoding.

For example, the motion vector can reference a reference block in a macroblock row in a reference frame that is lower than one or more previously referenced rows. In this case, the decoder can read the memory location of the keyword in the macroblock row in which the reference block is located to determine if the reference block is available for use. If the reference block is available for use, the decoder can proceed with decoding using the reference block. If the reference block is not available for use, the decoder can enter a polling state until the keyword is overwritten.

In an implementation of this disclosure, synchronization of the cores of a multi-core computing device is done using a memory-mapped register interface. In such an implementation, each of the cores can broadcast its progress (e.g., the current macroblock line number) in its memory-mapped registers, which can be read through the system bus as if they were addresses in an external memory. This approach can, in some cases, save the overhead of writing the keywords in the reference frames. In a system-on-a-chip (SoC) implementation, the cores are configured such that each is able to read the other core's registers to maintain synchronization.

Referring now to FIGS. 4 and 5, a technique for synchronizing staged cores (e.g., encoder cores) is to have a core processing an earlier frame feed output directly, i.e., without writing and reading reference frame data to/from primary memory (e.g., a DRAM), to the core processing the next frame. Generally, FIG. 4 illustrates frame data transfer of a multicore system without chaining and FIG. 5 illustrates frame data transfer of a multicore system with chaining.

More specifically, FIG. 4 depicts a multi-core computing device in accordance with an implementation of this disclosure. In FIG. 4, the cores of the multi-core computing device 400 are not chained. Computing device 400 includes control processor 410, primary memory 420, input/output port 430 and internal bus 440. Internal bus 440 may be a standard bus interface such as an Advanced Microcontroller Bus Architecture (AMBA) Advanced eXtensible Interface (AXI) which can be used as an on-chip bus in SoC designs. Control processor 410 can interconnect and communicate with the other components of computing device 400 via internal bus 440.

Computing device 400 may include primary memory 420 which can represent volatile memory devices and/or non-volatile memory devices. Although primary memory 420 is illustrated for simplicity as a single unit, it can include multiple physical units of memory which may be physically distributed. In an implementation, the volatile memory may be or include dynamic random access memory (DRAM). Computing device 400 may access a computer application program stored in non-volatile internal memory, or stored in external memory. External memory may be coupled to computing device 400 via input/output (I/O) port 430. A DRAM controller (not shown) can connect the I/O port to internal bus 400. A portion of video data may be received via I/O port 430 and stored in primary memory 420. In accordance with a SoC implementation of this disclosure, video data (e.g., reference frames) can be stored in external (off-chip) memory. For example, decoding 1080p video may require around 9 Mbytes of RAM, the cost of which can be commercially undesirable if implemented as on-chip SRAM rather than off-chip DRAM.

Computing device 400 can also include two or more cores: processors 450, 460, 470, . . . , 480. Each of the processors (e.g., cores) can have an associated memory. For example, each of the processors can have an associated on-chip cache memory. In another example, some or all of the cores can be associated with a shared on-chip cache memory or on-chip buffer memory. The memory locations in the shared on-chip cache memory can be segmented such that each processor has exclusive access to a portion of the shared memory, memory locations can be accessible by more than one processor, or a combination thereof.

Each of the processors can have a read new input video data line 452, 462, 472, 482; a read reference data line 454, 464, 474, 484; and a write reference data line 456, 466, 476, . . . , 486. Each of processors 450, 460, 470, . . . , 480 can execute executable instructions that cause the processor to perform a coding operation (e.g., encoding, decoding, or transcoding) on some portion of input video data received via read new input video data line 452, 462, 472, 482 and stored within an associated memory of each of the processors.

In one implementation, each of the processors 450, 460, 470, . . . , 480 can also include an output video data line (not shown). The output video data lines can be used to write video data output by the coding operation(s) performed by the processor(s) to, for example, the primary memory 420. In an alternative implementation, processors 450, 460, 470, . . . , 480 can write video data output to primary memory 420 via internal bus 440.

The cores of computing device 400 each may read input data (e.g., a new frame) and reference data (e.g. a reference frame) from the primary memory 420 via internal bus 440 coupled to their respective read new input video data line 452, 462, 472, 482 and read data reference lines 454, 464, 474, 484. Similarly, each processor also may write reference data (e.g., a reference frame) to the primary memory via its respective write reference lines 456, 466, 476, . . . , 486. Read input lines 452, 462, 472, 482, write reference lines 456, 466, 476, . . . , 486, and read reference lines 454, 464, 474, 484 can represent data flow via the standard bus interface such as AXI (e.g, each core 450, 460, 470, . . . , 480 might have one read data channel and one write data channel through which all data may transferred and by which they connect to internal bus 440).

FIG. 5 depicts a multi-core computing device in accordance with another implementation of this disclosure. In FIG. 5, the cores of the multi-core computing device 500 are chained. Computing device 500 can include control processor 510, primary memory 520, I/O port 530, and internal bus 540. The structure of each of these components can correspond to the description above with regard to like components of computing device 400.

Computing device 500 can include two or more cores: processors 550, 560, 570, . . . , 580. Each of processors 550, 560, 570, . . . , 580 may execute executable instructions that cause the processor to perform a coding operation (e.g., encoding, decoding, or transcoding) on some portion of input video data received via read new input video data lines 552, 562, 572, 582. Read new input video data lines 552, 562, 572, 582 can be implemented as channels on the standard bus interface. Video data received using read new input video data lines 552, 562, 572, 582 can be stored within an associated memory of each of the processors.

In one implementation, each of the processors 550, 560, 570, . . . , 580 can also include an output video data line (not shown). The output video data lines can be used to write video data output by the coding operation(s) performed by the processor(s) to, for example, the primary memory 520. In an alternative implementation, processors 550, 560, 570, . . . , 580 can write video data output to primary memory 520 via internal bus 540.

In an implementation, computing device 500 synchronizes operation of processors 550, 560, 570, . . . , 580 by connecting a write reference output of a first processor to the read reference input of a second processor via a write reference line, and connecting the write reference output of the second processor to the read reference input of a third processor via a write reference line, and so on to the Nth processor. For example, computing device 500 can synchronize operation of processors 550, 560, 570, . . . , 580 by connecting a write reference output of processor 550 to the read reference input of processor 560 via write reference line 556, and connecting the write reference output of processor 560 to the read reference input of processor 570 via write reference line 566, and so on to the Nth processor. In some cases, the connections from one core to another (e.g., the chained write reference output/read reference input) may be actual physical connections that are additional to the standard data buses of the internal bus system. The Nth processor can have a direct output reference 586 that may provide its reference to primary memory 520 via the bus interface 540, which may be a standard bus interface such as AMBA AXI.

The configuration of computing device 500 may allow for a processor (e.g., an encoder core) processing the earlier video data (e.g., earlier frames, macroblocks, a macroblock row, a slice, etc.) to feed its output directly (i.e., without writing and reading reference data to/from primary memory 520) to the processor processing the next portion of video data (e.g., to another encoder core processing the next frame, macroblock, etc.).

With this approach, a latter encoder core in the succession can begin its encoding task when it has collected sufficiently enough data to fill its internal search area memory. The first encoder core of the chain might not write out reference data unless the next encoder in the line is ready to receive it. Using such a technique, the cores can be synchronized by way of the reference data they submit and receive and additional control level synchronization logic can be avoided. In such an implementation, the slowest encoder core in the succession can determine the overall speed of the system.

By way of example, for the case of a single core encoder, three frames worth of data may need to be transferred over a system bus to encode one frame: (1) a new input frame to be read by the encoder core; (2) at least one reference frame to be read by the encoder, e.g., in the case of a typical inter frame coding scheme; and (3) at least one reference frame to be written by the encoder core, e.g., for subsequent processing. In accordance with an implementation of this disclosure with two or more encoder cores chained together, e.g., as described with regard to computing device 500, the first encoder core in the succession does not write its reference frame to primary memory 520, and the second encoder core does not read its reference from primary memory 520. Therefore, instead of transferring six frames worth of data to encode the two frames being processed by the two encoder cores, only four frames are transferred.

A generalization for N processors can operate in a similar manner: N processors can read new input video data from a memory, e.g., primary memory 520. Processor 1 can also read reference data from the memory, and processor N can write reference data to the memory. The processors in-between processor 1 and processor N can avoid reading/writing reference data from/to the primary memory. Hence, when the data are frames and the process is encoding, the number of frames to transfer FT for encoding N frames with N processors becomes:

F_{T}=N+2 [Equation 1]

The more processors chained together in computer device 500, the more efficient memory usage can become, for example:

F_{T}=3, when N=1

F_{T}=4, when N=2 (memory bandwidth can be reduced by 33% compared to single processor processing).

F_{T}=5, when N=3 (memory bandwidth can be reduced by 44% compared to single processor processing).

F_{T}=6, when N=4 (memory bandwidth can be reduced by 50% compared to single processor processing), and so forth.

In one implementation, N new input video frames of data is to be available for encoding before any of the N processors finish encoding a frame, after which a burst of N compressed frames can be output in a very short period.

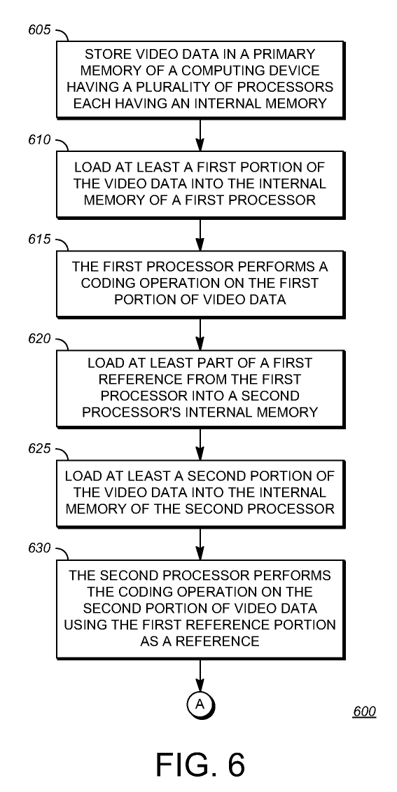

FIG. 6 depicts a process in accordance with an implementation of this disclosure. Specifically, FIG. 6 depicts process 600 for performing a coding operation on video data using a computing device having a plurality of processors each having an associated memory. At step 605, video data can be stored in a primary memory of the computing device. At least a first portion of the video data can be loaded, step 610, into the associated memory of a first processor. The first processor can perform a coding operation on this first portion of video data, step 615.

At least part of a first reference from the first processor can be loaded, step 620, into a second processor's associated memory. A second portion of video data can be loaded, step 625, from the primary memory into the associated memory of the second processor. The second processor can perform the coding operation, step 630, on the second portion of the video data using the first reference portion as a reference.

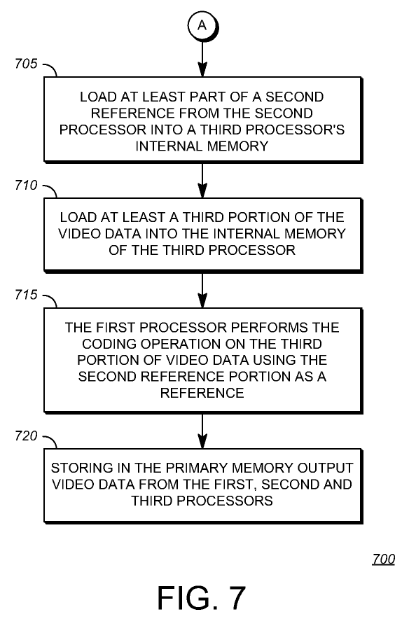

Process 600 continues at bubble A to process 700 (FIG. 7). FIG. 7 depicts process 700 for performing the coding operation on the computing device, where three or more processors may be implemented. At step 705, process 700 can load at least a part of a second reference from the second processor into a third processor's associated memory. A third portion of the video data can be loaded, step 710, into the associated memory of the third processor. The third processor can perform the coding operation, step 715, on the third portion of video data using the second reference portion as a reference. At step 720, the post-coding operation video data from the first, second, and third processors can be stored in the primary memory. Alternatively, the post-coding operation video data can be stored as the individual processor completes the coding operation on its respective portion of video data.

For simplicity of explanation, process 600 and 700 are depicted and described as a series of steps. However, steps in accordance with this disclosure can occur in various orders and/or concurrently. Additionally, steps in accordance with this disclosure may occur with other steps not presented and described herein. Furthermore, some of the described steps may not be required in some implementations.

In one aspect of this disclosure, encoding quality can be increased by using multiple reference frames. For example, in real-time video conferencing with a fixed camera position, it can be beneficial to do a motion search for another reference frame further in the past, such as one encoded at a particularly good quality (e.g., a long-term reference frame in the H.264 coding scheme or a golden frame in the VP8 coding scheme). In one implementation, some or all encoding cores of a multi-core encoder can be configured to read this same additional reference frame. In one implementation with chained encoder cores, the additional reference frame is read by only the first encoder core in the chain, and a delay buffer is inserted within each encoder core through which the additional reference frame propagates.

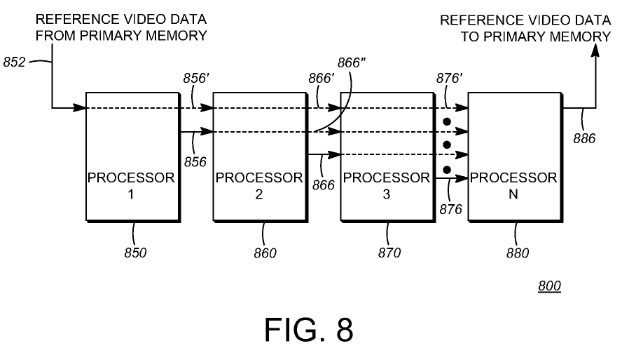

In one implementation using multiple reference frames, an increasing number of reference frames are employed by cores in the chain. This can be further appreciated with reference to FIG. 8.

FIG. 8 depicts a schematic of a multi-core computing device in accordance with one implementation of this disclosure. The computing device 800 includes N-cores: processor 1 through processor N. In FIG. 8, processor 1 is coupled to a memory (not shown) via line 852. Processor 1 and processor 2 are coupled via lines 856 and 856′; processor 2 and processor 3 are coupled via lines 866 and 866′ and 866″; and so forth. It shall be understood that lines 852, 856, 856′, 866, 866′, 866″, etc. may be physical lines connecting the corresponding processors or may be representative, e.g., of channels, data flow or data transmissions between the processors. In the latter case, lines 856 and 856′, for example, may representative two logically different data transmissions between processor 1 and processor 2, but the data transmissions may occur along the same physical line.

In use, processor 1 receives reference video data (e.g., a reference frame) from memory (e.g., a DRAM) (see line 852). For convenience, this reference frame is referred to in this paragraph as RF0. Processor 1, which in this example is the first core in the chain, uses the reference frame received from the memory, RF0, to encode a video frame. Processor 1 outputs data to processor 2 (see line 856). The data (e.g. a reconstruction of the frame encoded by processor 1) can be used by processor 2 as a reference frame. For convenience, this data is referred to in this paragraph as RF1. Processor 1 also outputs the reference frame it received from the memory RF0 to processor 2 (see line 856′). Processor 2 can use RF0 as an additional reference frame to encode a video frame. Processor 2 outputs data to processor 3 (see line 866). The data can be used by processor 3 as a reference frame. For convenience, this data is referred to in this paragraph as RF2. Processor 2 also passes along the data it received from processor 1, RF0 and RF1. Processor 3 can use RF0, RF1 and RF2 to encode a video frame. This can continue for additional cores in the chain until processor N.

Accordingly, in the example above, the first core in the chain can use one reference frame, the second core can use the output of the previous core as well as the input to the previous processor, the third core can use the output of the previous core as well as the input to the two previous processors, and so on. Encoders further in the succession may provide higher compression rates than the earlier encoders, as they may have the capability of finding better motion search matches due to the availability of more reference frames. Additionally, generally, for this increased encoding compression, no additional system bus bandwidth usage is incurred; however, each core further in the chain may employ more internal computational logic.

With regard to the performance of computing device 800, assuming each core performs at the same speed, the performance of the multi-core accelerator can be expressed as:

P_multi-core=P*N; wherein [Equation 2]

P is the performance of a single processor; and

N is the number of processors.

In addition, synchronization of the cores can introduce a latency component, which can be dependent on, for an encoder, the number of encoding cores in the encoding device, or, for a decoder, the maximum downwards pointing decoded motion vector. In this case the maximum can refer to a maximum positive/lower offset between a current block and a reference block referred to by a motion vector. For example, if a maximum downwards pointing decoded motion vector references a reference block in, for example, a substantially lower macroblock row, the latency component can be increased.

Some implementations of the disclosed techniques and devices can enable, for example, computing devices 400, 500, and/or 800 to encode and/or decode high video resolutions, such as those greater than 1080p. The ability for a computing device to process video data is based at least in part on a number of clock cycles required to process a unit of video data (e.g., a macroblock) and a clock rate of the core(s) used to perform the processing (i.e., cycles per second). The required processing rate for a particular video resolution can be determined based on a number of units per frame (e.g., 8,160 macroblocks in the case of 1080p) and a frame rate (e.g. 24 frames per second).

Some implementations capable of high resolution processing can include reducing a number of clock cycles required to process a unit of video data (e.g., a macroblock) in one or more cores, increasing a clock rate of one or more cores, splitting operations at a macroblock level, splitting operations at a macroblock row level, splitting operations at a slice level, or a combination thereof to enable a computing device to achieve the required processing rate for a given resolution and frame rate.

Splitting operations can include concurrent processing of portions of video data using separate processing cores. In one example, at the slice level, slices can be processed in groups according to a number of available processing cores. For example, if four processing cores are available, the first four slices to be processed can each be processed using a different core. Subsequent groups of four slices can also each be processed using a different core.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

The processors described herein can be any type of device, or multiple devices, capable of manipulating or processing information now-existing or hereafter developed, including, for example, optical processors, quantum and/or molecular processors, general purpose processors, special purpose processors, IP cores, ASICS, programmable logic arrays, programmable logic controllers, microcode, firmware, microcontrollers, microprocessors, digital signal processors, memory, or any combination of the foregoing. In the claims, the terms “processor,” “core,” and “controller” should be understood as including any of the foregoing, either singly or in combination. Although a processor of those described herein may be illustrated for simplicity as a single unit, it can include multiple processors or cores.

In accordance with an embodiment of the invention, a computer program application stored in non-volatile memory or computer-readable medium (e.g., register memory, processor cache, RAM, ROM, hard drive, flash memory, CD ROM, magnetic media, etc.) may include code or executable instructions that when executed may instruct or cause a controller or processor to perform methods discussed herein such as a method for performing a coding operation on video data using a computing device containing a plurality of processors in accordance with an embodiment of the invention.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and data configurations have been described herein, note that any number of other configurations may be provided in accordance with embodiments of the invention. Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the scope of the invention. Substitutions of elements from one embodiment to another are also fully intended and contemplated. The invention is defined solely with regard to the claims appended hereto, and equivalents of the recitations therein.

What is claimed is:

1. A method for performing a coding operation on video data using a computing device that includes primary memory, a plurality of cores each having an associated memory, and a bus coupling the primary memory to one or more of the plurality of cores, the method comprising:
storing the video data in the primary memory;
loading, via the bus, at least a first portion of the video data from the primary memory into the associated memory of a first core of the plurality of cores;
performing a coding operation, by the first core, on the first portion of the video data;
loading a first reference portion from the first core into the associated memory of a second core of the plurality of cores, wherein the first reference portion is loaded directly without being stored in the primary memory;
loading, via the bus, at least a second portion of the video data from the primary memory into the associated memory of the second core of the plurality of cores; and
performing the coding operation, by the second core, on the second portion of the video data using the first reference portion as a reference.

2. The method of claim 1, further including:
loading at least part of a second reference portion from the second core into the associated memory of a third core of the plurality of cores;
loading, via the bus, at least a third portion of the video data from the primary memory into the associated memory of the third core of the plurality of cores; and
performing the coding operation, by the third core, on the third portion of the video data using the second reference portion.

3. The method of claim 2, further including storing in the primary memory output video data from the first, second, and third cores.

4. The method of claim 1, wherein the coding operation of the second core and the third core begins after the respective associated memory of the second and third cores has loaded an amount of video data from the primary memory that is greater than a threshold.

5. The method of claim 2, wherein respective first and second reference portions are loaded after the respective second and third cores each provide an indication of being ready to receive a reference portion.

6. The method of claim 2, further comprising:
loading at least part of the first reference portion from the first core into the associated memory of the third core from the associated memory of the second core; and
wherein performing the coding operation by the third core includes using the first reference portion.

7. The method of claim 1, wherein the coding operations of the first core and the second core are synchronized using a memory-mapped register interface.

8. The method of claim 1, wherein the coding operations of the first core and the second core are synchronized using keywords written to a reference frame buffer.

9. The method of claim 1, wherein performing the coding operation by the second core includes:
identifying a current block of the second portion of the video data to be encoded;
identifying a search area in the first reference portion that is associated with the current block, the search area associated with a plurality of macroblock rows of the first reference portion;
reading a keyword memory location associated with each of the plurality of macroblock rows;
determining that none of the read keyword memory locations includes a keyword value; and
encoding the current block using the search area.

10. The method of claim 1, wherein performing the coding operation by the second core includes:
identifying a current block of the second portion of the video data to be encoded;
identifying a search area in the first reference portion that is associated with the current block, the search area associated with a plurality of macroblock rows of the first reference portion;
reading a keyword memory location associated with each of the plurality of macroblock rows;
determining that at least one of the read keyword memory locations includes a keyword value;
polling the read keyword memory location that includes the keyword value until the location does not include the keyword value; and
encoding the current block using the search area after the polling is completed.

11. The method of claim 1, wherein the first portion of video data is one of a macroblock, a macroblock row, a slice, or a frame.

12. A computing device comprising:
a plurality of cores, each core of the plurality of cores having an associated memory;
a primary memory coupled to the associated memory of two or more of the plurality of cores by respective lines of an internal bus;
wherein the first core of the plurality of cores is configured to perform a video data coding operation on a first portion of video data loaded into its associated memory from the primary memory; and
wherein the second core of the plurality of cores is configured to perform a video data coding operation on a second portion of video data loaded into its associated memory from the primary memory using a first reference portion that is loaded into the associated memory of the second core directly from the associated memory of the first core.

13. The computing device of claim 12, further comprising
a first video data reference line connecting the first core and the second core;
wherein the computing device is configured to load the first reference portion into the associated memory of the second core directly from the associated memory of the first core using the first video data reference line.

14. The computing device of claim 13, further comprising
a second video data reference line connecting the second core and a third core;
wherein the second core is configured to generate a second reference portion;
wherein the computing device is configured to load the second reference portion into the associated memory of the third core directly from the associated memory of the second core using the second video data reference line; and
wherein the third core of the plurality of cores is configured to perform a video data coding operation on a third portion of video data loaded into its associated memory from the primary memory using the second reference portion.

15. The computing device of claim 14, further comprising:
a third video data reference line connecting the second core and the third core;
wherein the computing device is configured to load the first reference portion into the associated memory of the third core directly from the associated memory of the second core using the third video data reference line; and
wherein the third core of the plurality of cores is further configured to perform the video data coding operation using the first reference portion.

16. The computing device of claim 12, further comprising
a plurality of respective output lines coupling the primary memory and the plurality of cores;
wherein each of the plurality of cores is configured to write output video data to the respective output lines for storage in the primary memory.

17. The computing device of claim 12, wherein the associated memory of the second core includes a reference frame buffer having a plurality of macroblock rows and the second core is configured to use respective keyword memory locations of the plurality of macroblock rows to synchronize its video data coding operation with the video data coding operation of the first core.

18. The computing device of claim 12, wherein the first portion of video data is one of a macroblock, a macroblock row, a slice, or a frame.

19. The computing device of claim 12, wherein the plurality of cores are a plurality of video encoder cores.

20. The computing device of claim 12, wherein the plurality of cores are a plurality of video decoder cores.
